(19) United States
(12) Patent Application Publication
(10) Pub. No.: US 2018/0007178 A1
(43) Pub. Date: Jan. 4, 2018

(54) METHOD AND SYSTEM OF DECOUPLING APPLICATIONS FROM UNDERLYING COMMUNICATION MEDIA THROUGH SHIM LAYERS

(71) Applicant: DINESH SUBHRAVETI, San Jose, CA (US)

(72) Inventor: DINESH SUBHRAVETI, San Jose, CA (US)

(21) Appl. No.: 15/463,219

(22) Filed: Mar. 20, 2017

Related U.S. Application Data
(60) Provisional application No. 62/321,736, filed on Apr. 13, 2016.

(51) Int. Cl. H04L 29/08; G06F 9/54; H04L 29/12

(52) U.S. Cl. CPC H04L 69/321; H04L 61/2007; G06F 9/547; H04L 69/329; H04L 67/1004

(57) ABSTRACT

In one example aspect, a computerized system of a shim layer that provides an application-level network overlay functionality without requiring any packet-level processing includes the step of implementing a shim layer underneath an application endpoint of an application, wherein the shim layer intercepts an application programming interface (API) between the application and the network and modifies a set of parameters exchanged in the API such that a network overlay is provided to the application. The method includes the step of assigning an identifier to the application endpoint, wherein the identifier can remain persistent when the application goes down and comes back up, and wherein the identifier can remain persistent when the application changes locations in a network.

This application claims priority to U.S. Provisional Application No. 62/321,736, titled METHOD AND SYSTEM OF SHIM LAYERS FOR APPLICATION NETWORKING, filed on 13 Apr. 2016. This application is incorporated by reference in its entirety.

### BACKGROUND

### 1. Field

This application relates generally to computer networking, and more particularly to a system, method and article of manufacture for shim layers for application networking.

### 2. Related Art

Regardless of the industry, a business may rely on software in today's world. However, operating software has been a challenge. Closer examination shows that, even though software and applications are intrinsically agile, they may be tied to hardware infrastructure, which makes them difficult to manage and operate. For example, applications may be tied to the identifiers assigned by underlying hardware. In particular, applications are tied to network identifiers such as an Internet protocol (IP) addresses.

Decoupling applications from underlying infrastructure has been one of the key focus areas for the computer software industry as a whole. Particularly, the industry has taken the approach running applications over equivalent software abstractions of otherwise hardware constructs for agility and manageability. Software Defined Networking and Software Defined Storage are examples of such abstractions. Since it provides a software abstraction of compute resources, the virtualization technology can be considered to be Software Defined Compute. These technologies can serve to decouple applications from infrastructure.

Container technology (or operating system level virtualization) is an evolution of hardware virtualization with substantial advantages. Given the high level in the software stack at which it operates, containers are able to decouple the applications even from different operating system variants and the clouds. They do so by providing operating system level constructs for the infrastructure resources they expose. For example, compute resources are exposed as processes, storage resources are exposed through a private file system view etc. When it comes to network, however, containers fall back to hardware level constructs. They may expose the network to the application as network devices. This can result in applications remaining coupled to the infrastructure from the network perspective.

This invention decouples the application from the underlying network through a shim layer, thereby truly decoupling the applications from the infrastructure and providing agility and manageability.

### BRIEF SUMMARY OF THE INVENTION

In one example aspect, a computerized system of a shim layer that provides an application-level network overlay functionality without requiring any packet-level processing includes the step of implementing a shim layer underneath an application endpoint of an application, wherein the shim layer intercepts an application programming interface (API) between the application and the network and modifies a set of parameters exchanged in the API such that a network overlay is provided to the application. The method includes the step of assigning an identifier to the application endpoint, wherein the identifier can remain persistent when the application goes down and comes back up, and wherein the identifier can remain persistent when the application changes locations in a network.

### BRIEF DESCRIPTION OF THE DRAWINGS

FIG. 1 illustrates an example system for implementing a transparent shim layer for intercepting and translating application network communication, according to some embodiments.

FIG. 2 illustrates an example historical process flow, according to some embodiments.

FIG. 3 illustrates an example system with a shim layer that provides a layer of indirection between the application and underlying network, according to some embodiments.

FIG. 4 illustrates, in block diagram format, an example shim layer, according to some embodiments.

FIG. 5 illustrates an example process for implementing policies at a shim layer, according to some embodiments.

FIG. 6 illustrates an example implementation of a shim layer process, according to some embodiments.

FIG. 7 depicts an exemplary computing system that can be configured to perform any one of the processes provided herein.

FIG. 8 illustrates an example process of a server listening for connection requests, according to some embodiments.

FIG. 9 illustrates an example implementation of a shim layer process, according to some embodiments.

FIG. 10 illustrates an example process of a computerized system of a shim layer that provides an application-level network overlay functionality without requiring any packet-level processing, according to some embodiments.

The Figures described above are a representative set, and are not an exhaustive with respect to embodying the invention.

### DESCRIPTION

Disclosed are a system, method, and article of method and system of method and system of shim layers for application networking. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Client-server model of computing can be a distributed application structure that partitions tasks or workloads between the providers of a resource or service, called servers, and/or service requesters, called clients

Cloud computing can involve deploying groups of remote servers and/or software networks that allow centralized data storage and online access to computer services or resources. These groups of remote serves and/or software networks can be a collection of remote computing services.

Communication endpoint can be the entity on one end of a connection (e.g. a transport layer connection, etc.).

File descriptor (FD) can be an abstract indicator (e.g. handle) used to access a file or other input/output resource, such as a pipe or network socket.

Gossip protocol can be a style of computer-to-computer communication protocol. Various versions of a gossip protocol that can be used include, inter alia: dissemination protocols, anti-entropy protocols, protocols that compute aggregates, etc.

InfiniBand (IB) can be a computer-networking communications standard that features very high throughput and very low latency. IB can be used for data interconnections among and/or within computers. IB can also be utilized a direct and/or switched interconnect between servers and storage systems, as well as an interconnect between storage systems.

Load balancing can include balancing a workload amongst multiple computer devices (e.g. servers).

Pipe can be a communication channel used for inter-process communication.

Shared memory can be memory that may be simultaneously accessed by multiple programs with an intent to provide communication among them or avoid redundant copies.

Shim can be a small library that intercepts API calls and changes the arguments passed, handles the operation itself and/or redirects the operation elsewhere.

Network socket (‘socket’) can be an end-point in a communication across a network or the Internet.

UNIX domain socket can be an end-point in local inter-process communication.

Virtual Extensible LAN (VXLAN) can be a network virtualization technology that attempts to improve the scalability problems associated with large cloud computing deployments.

### Example Systems

In some embodiments, a shim layer can be provided for an application (e.g. a client application, a server application, etc.). Each application can be provided an identifier. For example, the identifier can be a virtual IPv4 address. The identifier can remain persistent even when the application goes down and comes back up in a network. The identifier can remain persistent even though the application changes locations in the network.

It is noted that the shim layer corresponding to an application (e.g. an application endpoint, etc.) can provide the same virtual IPv4 address as the identifier expected by the application. This can be implemented per its configuration regardless of the address of the underlying network being otherwise assigned to the application. This can enable applications to be migrated to different environments and/or networks and still have them continue to communicate with each other without reconfiguration by referencing their old identities, even though the underlying environment assigns them different identities or network addresses. In some examples, the virtual identities and respective applications can constitute a highly-efficient overlay network. This network may not require translating the IP addresses contained within individual network packets and/or any type of per-packet processing in general, as required by technologies such as VXLAN, etc.

A ‘best’ (e.g. most efficient, available, fastest, etc.) medium of network communication for any two or more applications can be determined (e.g. when an application comes up in the network or any triggering event, on a periodic basis, etc.). Example network communication media include, inter alia: TCP/IP, Infiniband RDMA, UNIX sockets, shared memory, etc. For example, the fastest means of communication available to two applications running on two virtual machines hosted by the same physical machine is shared-memory. ‘Best’ can be interpreted based on the context and/or available computer network(s). For example, ‘best’ can mean most efficient, fastest, most secure, most local, etc.

The shim layer of an application can keep a list of the various available network communication media. The shim layer of the application can track the current ‘best’ (e.g. based on the application's context, factors provided supra, etc.) network communication medium to communicate with a target application. For example, the source application can be a client application and the target application can be a server application. The shim layer can intercept the communication from the application (e.g. through the BSD socket API etc.) can map the communication to another best-available network communication medium. The communication can be sent to the server over the best-available network communication medium. The corresponding shim layer of the receiving server can translate the communication back into the expected API. In this way neither the client application nor the server application are aware of the interception and translation by their respective shim layers. The respective shim layers can identify the client application and/or the server application by their respective identifiers as well. Accordingly, each application can maintain a persistent identifier upon location changes or other events that would lead to a change in the identifier in a prior art context. However, while the identifier can remain persistent, that does not prevent an operator from specifying an alternate identifier if needed. In that case, the updated mapping between the identifier of the application and the identifier of the underlying network medium is advertised among shim layers on other hosts in the network.

In some embodiments, the application can communicate with the underlying platform via an API. Accordingly, as used herein, ‘intercept’ and the like can be used to mean intercepting these API calls and not (in most cases) the actual data-path communication of the application to the other network entity (e.g. a server or a client, etc.). For example, an application's communications to the platform requesting to create a socket, to connect to the other network entity and/or other control elements of the API can be intercepted. The data path (e.g. read and/or write applications) are not intercepted in most cases. For example, the data path is not intercepted for connection oriented communication protocols where the API functions for data transfer do not include endpoint identifiers.

### Example Methods and Processes

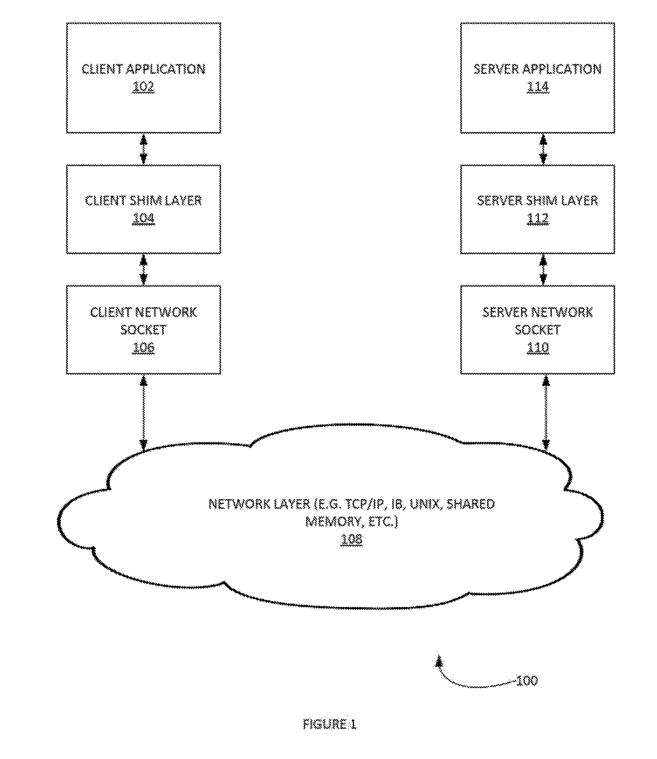

FIG. 1 illustrates an example system 100 for implementing a transparent shim layer for intercepting and translating application network communication, according to some embodiments. Example system 100 can include a client application 102. Client application 102 can seek to communicate with server application 114. In lieu of directly communicating with server application 114 via computer network(s) 108, client application 102 can be coupled with client shim layer 104.

Client shim layer 104 can be a library that intercepts network communication API calls from client application 102. It can also be a kernel module that intercepts the application's network API functions within the kernel. Client shim layer 104 can change/translate the parameters of the network communication API passed and redirect the communication through a currently ‘best’ network communication medium.

Policy enforcement examples are now discussed. Client shim layer 104 can also implement policies provided by a system administrator. Policies can include load balancing policies, firewall policies, security policies, etc. For example, a list of permissions and/or restrictions of which entities (e.g. servers) client application 102 can communicate with can be obtained by client shim layer 104. Client shim layer 104 would review all network communication requests and block those that violate the list of permissions and/or restrictions. In another example where a client-side load balancer is implemented, a current list of server backends can be maintained by client shim layer 104. When a network communication request is received from client application 102, client shim layer 104 can determine which servers are available and direct network communication to the most suitable server.

Unlike technologies that use tunneling or per-packet network address translation mechanisms, the shim layer operates much closer to the application and hence has access to meaningful application events with rich semantic information that can be used to monitor the application behavior and to express and enforce policy. This can also apply on the server side policy as provided infra.

Client network socket 106 can be an interface that uses various kinds of media that peers can communicate within a network layer 108 (e.g. TCP/IP, IB, UNIX, shared memory, etc.). Client shim layer 104 can communicate with server application 114 via these media.

Server application 114 can maintain server network socket 110. For example, server network socket 110 can be created through a BSD (i.e. Berkeley Sockets) socket interface. Server application 114 can create a socket and bind it to a port and address and then listen for client application 102 (and/or other clients) to connect to a client application. Server application 114 can be coupled with server shim layer 112.

Server shim layer 112 can be a library that intercepts network communication from client application 102 and/or server application 114. Server shim layer 112 can change/translate the network communication passed and redirect the communication through a currently ‘best’ network communication medium. Server shim layer 112 can also implement policies provided by a system administrator. Policies can include load balancing policies, firewall policies, security policies, etc. For example, a list of permissions and/or restrictions of which entities (e.g. various client applications) server application 114 can communicate with can be obtained by server shim layer 112. Server shim layer 112 can review all network communication requests and block those that violate the list of permissions and/or restrictions. In another example, server shim layer 112 can communicate server load information to an administrative entity for redistribution and/or client-shim layers.

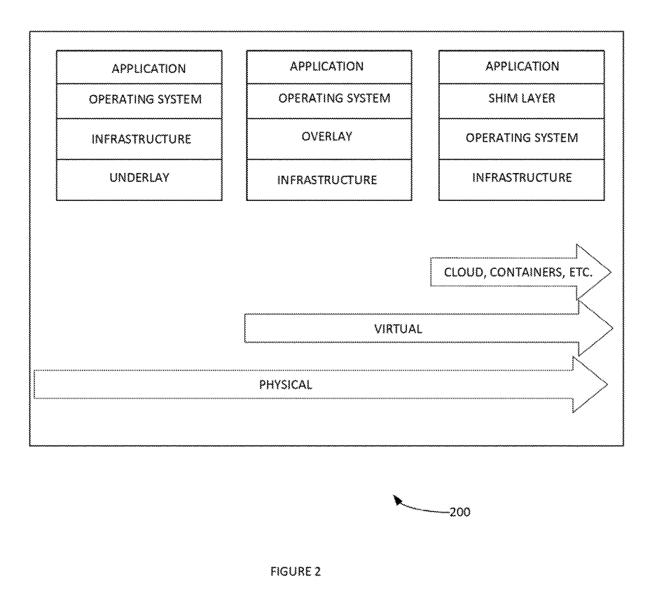

FIG. 2 illustrates an example historical process 200 flow, according to some embodiments. Applications accessed the network underlay without any layer of indirection in the case of bare metal infrastructure. When virtual machines entered the market, network overlays were introduced as a layer of indirection to underlying network. With more modern infrastructure elements such as cloud and containers, the layer of indirection (e.g. referred in this document as the shim layer) needs to move closer to the application.

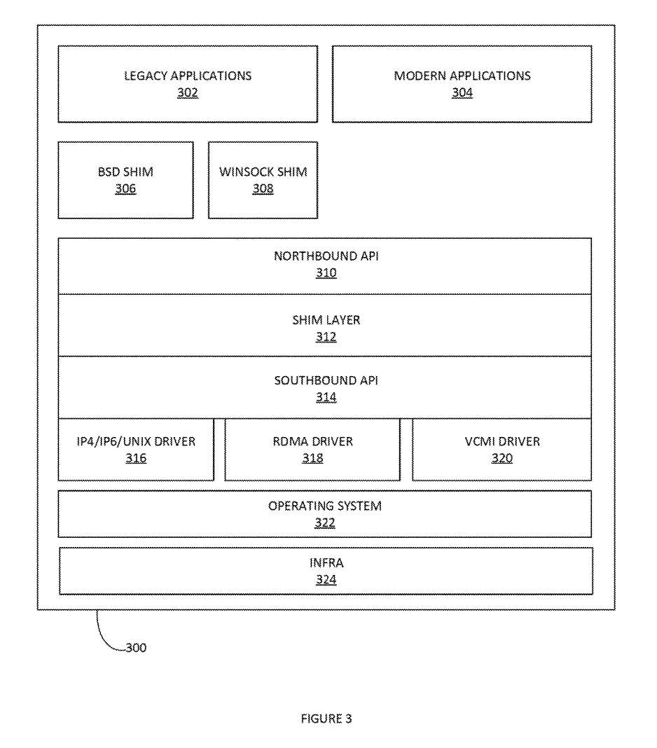

FIG. 3 illustrates an example system 300 with a shim layer that provides a layer of indirection between the application and underlying network, according to some embodiments. System 300 can include legacy application(s) 302 and modern application(s) 304. legacy application(s) 302 can use a legacy network API (such as a BSD socket interface or a Winsock interface, etc.) to access the northbound API 310 of the shim layer 312 through respective shims (Berkeley Software Distribution (BSD) shim 306, Winsock shim 308, etc.).

Shim layer 312 provides an optimal northbound interface through which applications access the network. Shim layer 312 includes support for the necessary network functions which are commonly required by most modern applications 304 such that they don't have to be separately built per application. Shim layer 312 also provides a southbound interface 314 that allows a variety of network or communication media to be plugged into shim layer 312 and then made available to the consumer applications of the northbound interface 310.

Southbound interface 314 can be coupled with various drivers (e.g. IP4/IP6/UNIX driver 316, RDMA driver 318, VCMI driver 320, etc.) and can communicate with operating system (OS) 322 and Infra 324 (e.g. computer system infrastructure).

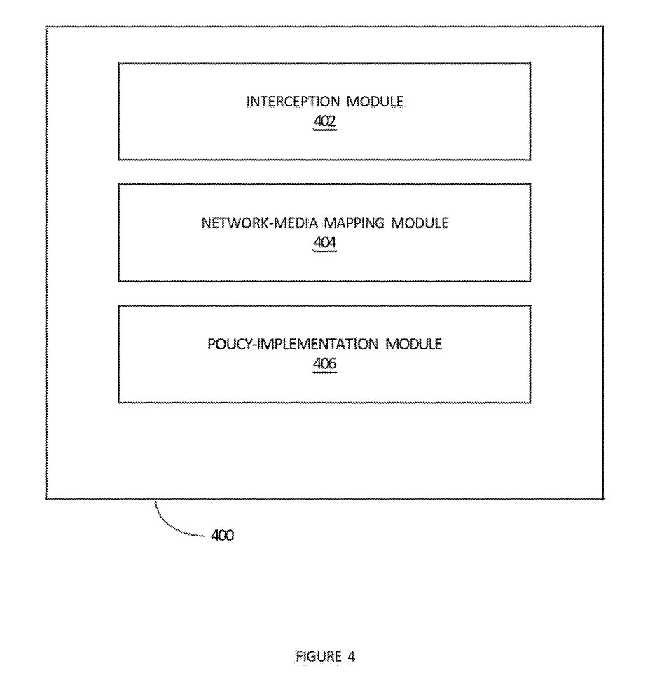

FIG. 4 illustrates, in block diagram format, an example shim layer 400, according to some embodiments. Shim layer 400 can include an interception module 402. Interception module 402 can intercept network communication API calls from an application and convert/translate said calls to those corresponding to other network communication medium for communication through a medium. Interception module 402 can optimize the network communication medium for data received from an application. Interception module 402 can determine a most efficient medium possible. Interception module 402 can determine the context of the application and the target application. For example, both the application and the target application can be in the same UNIX system. Interception module 402 can emulate a TCP/IP based BSD API from the application over a UNIX socket which is more efficient. Interception module 402 can also translate a virtual address of the target application used by the application to an appropriate address for communication of the target protocol. Interception module 402 can track various entities in the computer network based on their respective virtual identifier (e.g. identifiers, etc.).

In an example method, various clients and servers can be provided virtual identities. These virtual identifiers can correspond to the underlying network medium. They can be decoupled from the identifiers the servers and/or clients believe they are interacting with. For example, a client can be provided the virtual identifier—1.1.1.1. A server can be provided the virtual identifier 2.2.2.2. The client can ‘think’ that it is an IPv4 host using a TCP/IP address. However, a shim functionality can conduct its communications to 2.2.2.2 over shared memory because 1.1.1.1 and 2.2.2.2 are on the same host (and/or UNIX sockets because they are on same host). If server moves, client can still find server based on the virtual identifier server is mapped to. For example, the client can connect to 2.2.2.2. The shim layer can intercept the call and translate it to the actual identifier to which 2.2.2.2 is mapped. For example, the shim layer can translate it to a UNIX address (such as /var/run/server.sock) at which server is listening. The server ‘thinks’ that it is listening on 2.2.2.2 and not UNIX address. However, the server's corresponding shim layer can be listening on multiple interfaces and does mapping from multiple interfaces to the interface the server ‘thinks’ it is listening on. In this way, virtual identifiers can be unknown to layers below the shim layer and are kept consistent to the application. The 2.2.2.2 identifier can be mapped to a set of physical identities/addresses. It is noted that the shim layer of client analyzes context and translates to the most suitable medium. For example, if the client and server are on the same host then a UNIX connection may be the most efficient/fastest. The shim layer can select the UNIX protocol as medium of communication, establish the UNIX connection and network over a UNIX socket. At the same time, neither the client nor server know that communication is happening over a UNIX socket but believe they are communication via TCP/IP protocols. The shim layer can appropriately intercept API calls such as getsockname, getpeername etc. to ensure that transparency.

If server moves to a different location (e.g. instantiated on different host), the shim layer(s) can change/update underlying mappings. The client can still reach same server at previously known virtual address even though the underlying mappings were updated do to the new location. Accordingly, the present method provides a decoupling from the ‘actual’ network layer substrate while retaining a well-known/universally known virtual address (e.g. can be in form of an IP address).

Additionally, the decoupling of the application from the network by the shim layer(s) can allow system to apply newer methods to legacy applications. For example, legacy applications need not be re-configured to connect with clients as the shim layer can include the necessary updates.

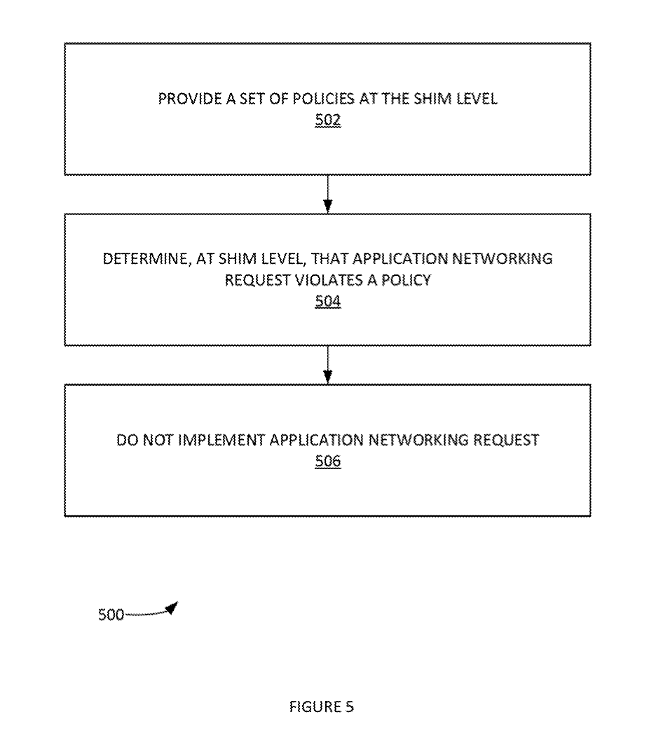

FIG. 5 illustrates an example process 500 for implementing firewall policies at a shim layer, according to some embodiments. Process 500 can provide a set of policies at the shim layer in step 502. Process 500 can determine, at shim layer, that application-networking request violates a policy in step 504. Process 500 cannot implement application-networking request in step 506. Process 500 can be adapted for load-balancing operations as well. Process 500 can be adapted for other policy-based operations (e.g. various security operations). For example, a shim layer can schedule incoming/outgoing client requests (depending on which side the shim is). When client is connecting to server, client can decide which server to connect. In this way, firewalls and/or load-balancing systems can be decentralized and/or made scalable. Decisions can be made locally at the client side and can be checked by a corresponding shim layer on the server side as well.

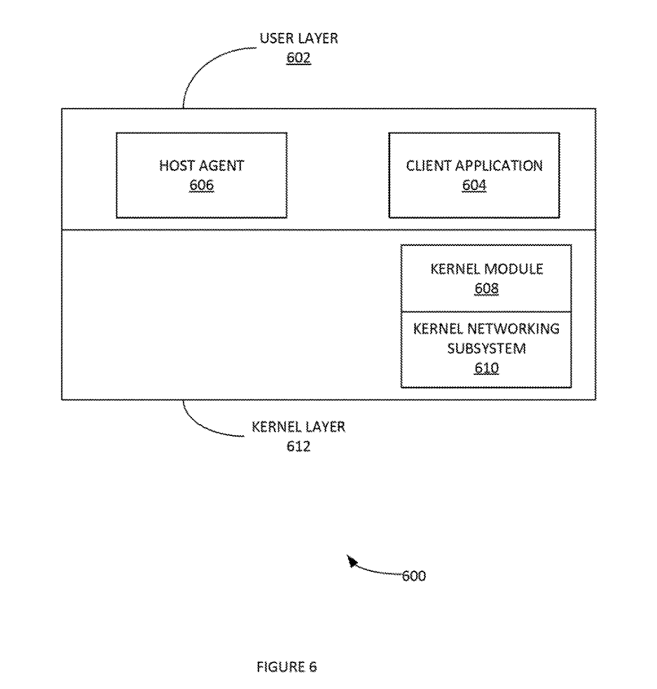

FIG. 6 illustrates an example implementation of a shim layer process 600, according to some embodiments. It is noted that, applications can communicate to each other over communication end points. A communication end point can be an abstracted equivalent of a network interface (e.g. a port, etc.). At the application level, the communication end point can be a file descriptor (e.g. handle to a bit-pipe into which peer applications read and write bits etc.). A communication endpoint can also be a server listening socket, a virtual interface within a container, a network namespace, etc.

Client application calls can be intercepted at various layers of the software stack (e.g. kernel layer 612, etc.). In a kernel-based interception mechanism, a host agent 606 (e.g. a user-space entity) can be provided. A client application 604 in a user layer 602 to be controlled can be provided. BSD socket calls from client application 604 can be intercepted. In lieu of the kernel implementing the calls with a kernel networking subsystem 610, an alternate system call interface for BSD socket calls can be provided through a kernel module 608. Typically, the system call interface can forward networking calls to the kernel networking subsystem 610 for client application 604. However, kernel module 608 can be placed to intercept calls from client application 604 (e.g. using trace points to intercept call in Linux, etc.).

Host agent 606 can register itself as the proxy/handler for these calls. Host agent 606 can service these calls. For example, socket-related system calls can be forwarded by the kernel module 608 to the host agent 606. The host agent 606 can service the socket-related system calls. The socket-related calls are intercepted by the kernel module 608 in the kernel layer and forwarded to the host agent, while the data itself is not touched. For example, the host agent 606 can use a file descriptor passing mechanism rather than acting like a proxy. The host agent 606 can create a socket on behalf of the client application. The client application 604 can be sitting in a network namespace of its own. This namespace may not have any network access but through the host agent 606. The host agent 606 can pass the socket to the client application. This can be implemented through a UNIX domain socket. The UNIX socket supports a file-descriptor passing mechanism. The same file-descriptor passing mechanism may also be implemented over another socket family such as Linux's netlink socket family. The kernel module 608 can forward calls to the host agent via the UNIX socket. The kernel module 608 can receive the socket the host agent has created. The kernel module 608 can install the socket in the client application. Once file descriptor is passed back to the client application, the host agent 606 need not continue to be in the data path. The file descriptor can be a fully-formed endpoint over which the client application can read and/or write data. In this way, client application 604 can connect to other entities in the network. The client application 604 may have asked for a TCP/IP socket, for example. However, the host agent 606 is returning a UNIX socket to it. The UNIX socket can behave and appear to the client application to be a TCP/IP socket as querying the file descriptor tells the client application it is a TCP/IP socket.

In the case where network namespace is considered to be the communication endpoint, a virtual network identity is projected into the network namespace by intercepting the network API calls originating from processes within the namespace. The network identity can be a virtual network interface projected to the application when the application queries for it. It could be a simple dummy interface configured with an IPv4 address assigned to that end point as the identifier. Network API calls originating within the namespace can be intercepted and forwarded to an agent running in the host network namespace. Even though the network namespace acting as the communication end point is not provisioned with any real network interfaces, the applications would be able to reach the network by having their network calls forwarded to the host agent which would have access to the network interfaces of the host. Conceptually, the host agent could be considered as the “network hypervisor” for the namespace which services the network API calls originating within the namespace.

Tracepoints and file descriptors are now discussed. Tracepoints are a marker within the kernel source which, when enabled, can be used to hook into a running kernel at the point where the marker is located. It is noted that any kernel mechanism that allows intercepting and modifying relevant application events is enough. Tracepoints are one such mechanism. In UNIX and related computer operating systems, a file descriptor can be an abstract indicator (e.g. a handle) used to access a file or other input/output resource, such as a pipe or network socket. File descriptors can form part of the POSIX application-programming interface. A file descriptor can be a non-negative integer.

In one example, a server application runs within a network namespace. The operating system kernel on which the application is running can intercept the socket API calls (e.g. a bind call). For each API call the client invokes, the kernel would forward the call to the host agent over the UNIX domain socket. The host agent can, in turn, emulate the call on the host to support the features of the shim layer (e.g. decoupling the application from network addresses and support for multiple connectivity media.) The server can seek to create a socket and bind it to certain IP address and a port. Respective API calls can be sent from the kernel to the host agent. The host agent can then create multiple handles corresponding to the connectivity media (e.g. TCP/IP, IB, UNIX, etc.) available on the host and bind those handles to addresses appropriate for the respective medium. As a specific example, the host agent can create an INET, a UNIX socket and an IB endpoint and bind them to appropriate endpoint addresses. The semantics of the underlying medium may not always align with the BSD socket interface. If so, host agent appropriately emulates the API. The host agent can wait for connections on each of the sockets. A client application wishes to connect to the server. In one example, a local client and server can be connected via UNIX connection. The server is already listening on UNIX socket. The shim layer below the client knows that the server is listening on multiple network interfaces and chooses UNIX because it is currently faster than the others. The host agent (of the server) accepts the UNIX socket connection. The file descriptor of the UNIX socket is then passed to the client application through the file descriptor passing mechanism available on UNIX systems. The client application receives the file descriptor and uses it. Even though the client originally asked created an INET socket the shim layer would replace the original socket with the UNIX socket received through file descriptor passing mechanism. Since the connection is already established, the client application can treat the file descriptor just as a bit pipe.

It is noted that a host agent can make various decisions based on policies. The host agent can determine if a connection can be made based on said policies. In the case of a distributed fire wall/load balancer, the host agent can run as a root user (e.g. have a specified set of privileges). Calls made by client application are intercepted in the kernel layer. As a root user, the host agent can ensure that the policies are not compromised.

It can be ensured that the API calls made by the application are always intercepted. For example, applications cannot circumvent kernel based interception mechanisms. The authenticity of the shim layer can be ensured by having the corresponding binary owned by the root user with setuid flag set.

A port range based firewall policy is now provided. A port range for communication among the clients and servers controlled by the shim layer can be reserved. On each host, non-shim-using applications cannot bind to any port in the reserved range. If a non-shim-using application attempts to bind to a port in the reserved port range, it is denied. Similarly, the shim layer ensures that the actual ports used by the shim-using applications are always within the reserved port range. In one example, the firewall policy can be implemented by dropping connections with source port outside of the reserved port range.

Hosts participating in the cluster can register with a central node known as a manager node. The manager node has knowledge of all the hosts using the shim layer. If request is coming from an unregistered host, it is dropped. These rules can be utilized in the distributed firewall example.

In one example, client attempts to reach a server. Client needs to map the virtual identity of the server to the physical endpoint. Those mappings are stored in a registry. Registry can be a map of virtual to actual/physical endpoints. Registry can be a central database of such mappings. The shim layer running below a client or a server application can consult the database to convert a virtual identifier to an actual identifier.

The mappings could also be exchanged in a distributed fashion. When a server binds to a virtual IP address, it can use a gossip protocol to let interested hosts know that it is available. The gossip mechanism can be a distributed systems mechanism that passes events to a large number of listeners. Accordingly, the advertisement of mappings is done with the gossip protocol via a system that implements the gossip medium (e.g. XMPP, Serf). Clients also participate in gossip protocol. For example, they can listen to the gossip protocols provide the mappings and put the mappings in its memory at a private mapping table. A client or server can be applications running on a host. Accordingly, this process can be implemented by a host agent.

In one example, the kernel can receive calls from client or server applications. The calls can refer to the file descriptor. The socket file descriptor may not be unique. The file descriptors can be integers and multiple file descriptors can point to a single socket. Kernel can learn the file descriptor from the call parameters. It may not pass this directly to the host agent because it may not uniquely identify the socket on which the operation is to be made. It can then look up the unique i-node number of the socket and share the i-node number with the agent. The mapping between application sockets and socket that host agent is maintaining on behalf of the application is consistent with the i-node number as the index. In other words, the host agent tracks the sockets used by applications on the host in an i-node table that maps the application's socket to a vector of sockets/physical interface end-points that host agent maps. In the event that a client application requests a listen call, then the host agent listens on the all the physical endpoints on which the particular socket maps to in the i-node table. In this way, multiple endpoints are multiplexed into one socket.

Additional Exemplary Computer Architecture and Systems

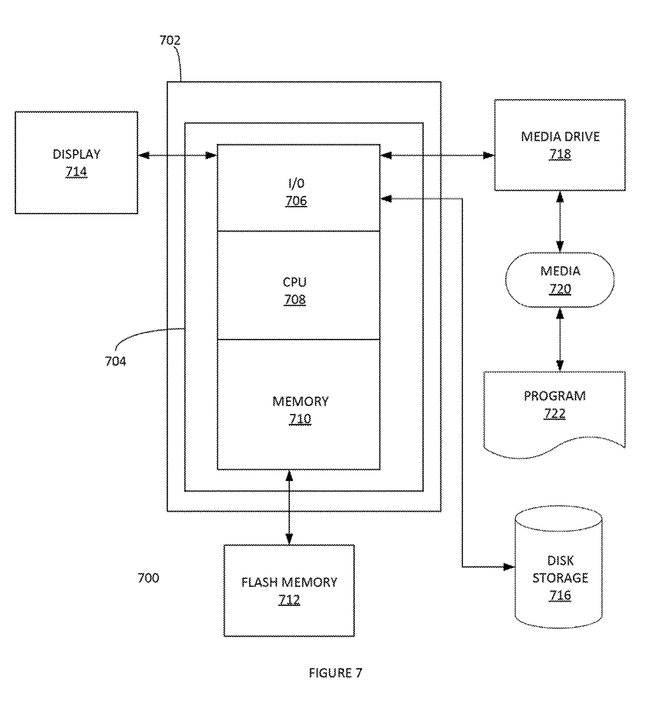

FIG. 7 depicts an exemplary computing system 700 that can be configured to perform any one of the processes provided herein. In this context, computing system 700 may include, for example, a processor, memory, storage, and I/O devices (e.g., monitor, keyboard, disk drive, Internet connection, etc.). However, computing system 700 may include circuitry or other specialized hardware for carrying out some or all aspects of the processes. In some operational settings, computing system 700 may be configured as a system that includes one or more units, each of which is configured to carry out some aspects of the processes either in software, hardware, or some combination thereof.

FIG. 7 depicts computing system 700 with a number of components that may be used to perform any of the processes described herein. The main system 702 includes a motherboard 704 having an I/O section 706, one or more central processing units (CPU) 708, and a memory section 710, which may have a flash memory card 712 related to it. The I/O section 706 can be connected to a display 714, a keyboard and/or other user input (not shown), a disk storage unit 716, and a media drive unit 718. The media drive unit 718 can read/write a computer-readable medium 720, which can contain programs 722 and/or data. Computing system 700 can include a web browser. Moreover, it is noted that computing system 700 can be configured to include additional systems in order to fulfill various functionalities. Computing system 700 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

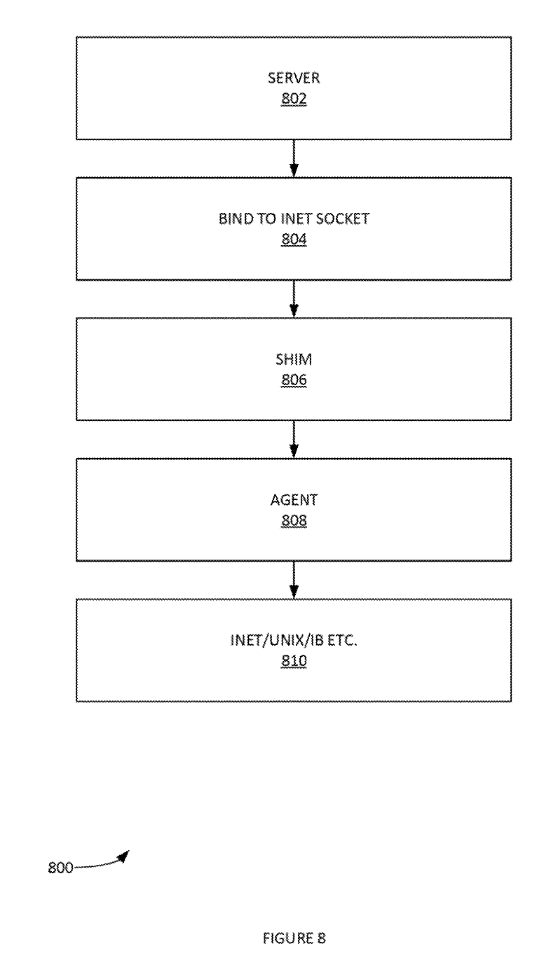

FIG. 8 illustrates an example process 800 of a server listening for connection requests, according to some embodiments. Process 800 can enable server 802 listen for connection requests on multiple different network media even though the application itself just asks to listen on INET interface. Server 802 can bind to shim layer 806 using an INET socket in step 804. Agent 808 can perform the same functions as host agent 606 of FIG. 6 supra.

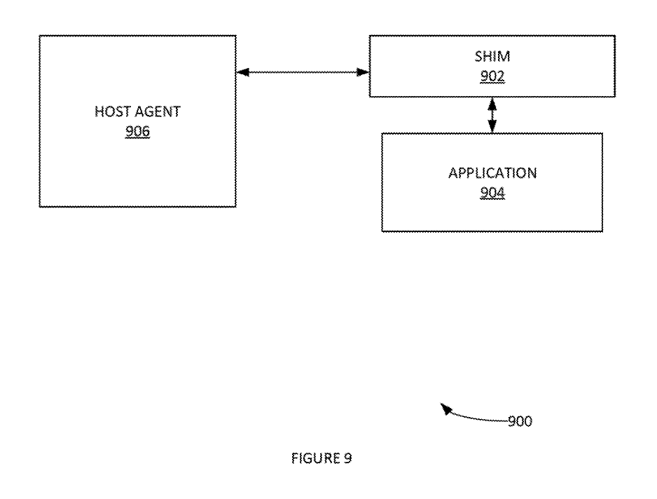

FIG. 9 illustrates an example implementation of a shim layer process 900, according to some embodiments. Process 900 can be a variation of process 600 provided supra. UNIX-based FD pairing can be implemented between shim 902 and host agent 906. The FD pairing can include system call forwarding. Host agent 906 can include a host-network namespace. In various example embodiments, shim 902 can be implemented by a kernel module or UNIX socket. Application 904 can be implemented with a private network namespace.

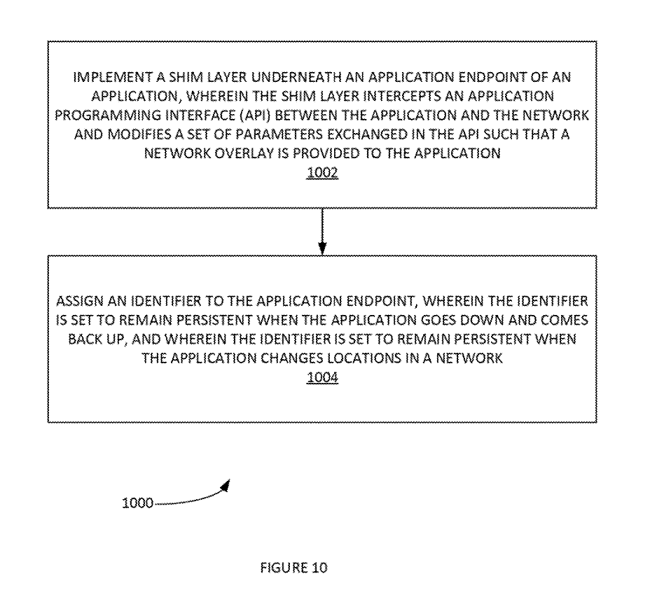

FIG. 10 illustrates an example process 1000 of a computerized system of a shim layer that provides an application-level network overlay functionality without requiring any packet-level processing, according to some embodiments. In step 1002, process 1000 can implement a shim layer underneath an application of an application, wherein the shim layer intercepts an application programming interface (API) between the application and the network and modifies a set of parameters exchanged in the API such that a network overlay is provided to the application. In step 1004, process 1000 can assign an identifier to the application, wherein the identifier is set to remain persistent when the application goes down and comes back up, and wherein the identifier is set to remain persistent when the application changes locations in a network.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method of a shim layer that provides an application-level network overlay functionality without requiring any packet-level processing comprising:
implementing a shim layer underneath an application endpoint of an application, wherein the shim layer intercepts an application programming interface (API) between the application and the network and modifies a set of parameters exchanged in the API such that a network overlay is provided to the application; and
assigning an identifier to the application endpoint, wherein the identifier is set to remain persistent when the application goes down and comes back up, and wherein the identifier remains persistent when the application is restarted or changes locations in a network.

2. The computerized method of claim 1, wherein the shim layer implements a distributed load balancer by selecting a server application endpoint from a set of available server endpoints with the same identifier based on a specified criterion when a client application endpoint needs to access a server with a specified identifier.

3. The computerized method of claim 1, wherein the shim layer selects a network communication medium between two application endpoints to communicate based on a criterion such as speed by transparently converting the API calls made by each application endpoint into the API calls required by the selected communication medium.

4. The computerized method of claim 1, wherein the shim layer reviews all API requests, records relevant pieces of data for visibility, monitoring or analytics and/or blocks a set of API requests that violate a specified policy.

5. The computerized method of claim 1, wherein the identifier is a virtual Internet Protocol version 4 (IPv4) address.

6. The computerized method of claim 1, wherein a network communication medium comprises a Transmission Control Protocol (TCP/IP) medium, an Infiniband Remote Direct Memory Access (RDMA) medium, a UNIX sockets medium or a shared-memory medium.

7. The computerized method of claim 1, wherein the shim layer intercepts an application's network API functions through a kernel-module based implementation or a user-space based implementation.

8. The computerized method of claim 1, wherein the shim layer communicates a current mappings between the identifier assigned to the application endpoints and a unique identifier of the host where the application endpoint is located with other shim layers on other hosts.

9. The computerized method of claim 8, wherein the shim layer communicates the current mappings with other shim layers on other hosts through a gossip protocol.

10. The computerized method of claim 1, wherein the shim layer locally caches a set of relevant mappings.

11. The computerized method of claim 1, wherein the API between the application and the network comprises a Berkeley Software Distribution (BSD) socket interface.

12. The computerized method of claim 7, wherein the user-space based implementation comprises a ptrace or an LD_PRELOAD operation.

13. A computing system of a shim layer that provides an application-level network overlay functionality without requiring any packet-level processing comprising:
a processor configured to execute instructions;
a memory containing instructions when executed on the processor, causes the processor to perform operations that:
implement a shim layer underneath an application endpoint of an application, wherein the shim layer intercepts an application programming interface (API) between the application and the network and modifies a set of parameters exchanged in the API such that a network overlay is provided to the application; and
assign an identifier to the application endpoint, wherein the identifier is set to remain persistent when the application goes down and comes back up, and wherein the identifier is set to remain persistent when the application changes locations in a network.

14. The computing system of claim 13, The computerized method of claim 1, wherein the shim layer implements a distributed load balancer by selecting a server application endpoint from a set of available server endpoints with the same identifier based on a specified criterion when a client application endpoint needs to access a server with a specified identifier.

15. The computing system of claim 13, wherein the shim layer selects a network communication medium between two application endpoints to communicate based on a criterion such as speed by transparently converting the API calls made by each application endpoint into the API calls required by the selected communication medium.

16. The computing system of claim 13, wherein the shim layer reviews all API requests, records relevant pieces of data for visibility, monitoring or analytics and/or blocks a set of API requests that violate a specified policy.

17. The computing system of claim 13, wherein the identifier is a virtual Internet Protocol version four (IPv4) address.

18. The computerized system of claim 13, wherein a network communication medium comprises a Transmission Control Protocol (TCP/IP) medium, an Infiniband Remote Direct Memory Access (RDMA) medium, a UNIX sockets medium or a shared-memory medium.

19. The computerized system of claim 13, wherein the shim layer intercepts an application's network API functions through a kernel-module based implementation or a user-space based implementation.

20. The computerized system of claim 13,
wherein the shim layer communicates a current mappings between the identifier assigned to the application endpoints and a unique identifier of the host where the application endpoint is located with other shim layers on other hosts,
wherein the shim layer communicates the current mappings with other shim layers on other hosts through a gossip protocol,
wherein the shim layer locally caches a set of relevant mappings,
wherein the API between the application and the network comprises a Berkeley Software Distribution (BSD) socket interface, and
wherein the user-space based implementation comprises a ptrace or an LD_PRELOAD operation.
